(19) United States
(12) Patent Application Publication
(10) Pub. No.: US 2013/0345879 A1
(43) Pub. Date: Dec. 26, 2013

(54) Communication Method in a System Comprising a Power Unit and a Communication and Home Automation Actuator

(71) Applicant: Somfy SAS, Cluses (FR)

(72) Inventors: Claude Desbiolles, Eteaux (FR); Florian Germain, Meythet (FR); Daniel Mugnier, Passy (FR); Stephane Riffaud, Sallanches (FR)

(21) Appl. No.: 13/911,768

(22) Filed: Jun. 6, 2013

Related U.S. Application Data
(63) Continuation-in-part of application No. PCT/EP2012/074704, filed on Dec. 6, 2012.

(30) Foreign Application Priority Data
Dec. 6, 2011 (FR) 1161198

(51) Int. Cl. G05B 15/02

(52) U.S. Cl. CPC G05B 15/02
USPC 700/275

(57) ABSTRACT

A communication method for a home automation actuator comprising an electric motor driving a moving element in a building and two electric terminals making it possible to power the actuator by a power supply and communication entity and allowing communication between the actuator and the power supply and communication entity, the method comprising the following steps:
analysis of a power supply signal supplied by the power supply and communication entity;
generation of a first time-sequence of a response signal, representative of a predetermined calibration binary element, called first calibration sequence;
sending of a series of time-sequences of the response signal, representative of a series of binary elements, each binary element of this series, equal to the calibration binary element, being represented by a time-sequence which is an image of the first calibration sequence.

### FIELD OF THE INVENTION

The invention relates to the field of home automation installations comprising electric actuators for driving a moving element in a building, such as closures or solar protection means.

These actuators, in normal operation on the site, are controlled via a wireless interface and/or a wired interface.

Throughout the development, production, assembly of the supporting product in the factory, identification and diagnostic testing of an actuator on site, it is necessary to dialog with the actuator, to transmit and/or receive information such as date of assembly, torque, speed, serial number, etc.

This dialog is performed using a power supply and communication entity that is capable of powering the actuator and of communicating therewith.

The communication must be performed in such a way as to cover the whole range and with a minimum cost overhead.

### PRIOR ART

Solutions for implementing communication between an actuator and a power supply and communication entity are known, for example using a wired interface of UART or USB type. Dedicated interfaces and components have to be used for the connection, which induces an increase in the cost and complexity of the products. Furthermore, for the programming of these interfaces, the bit rate and the data format have to be known in advance by the actuator and the power supply and communication entity.

A communication will be implementable only between a sender and a receiver sharing the same bit rates and data formats. Because of this, a power supply and communication entity will be able to communicate only with a subset of the range of actuators.

The parameters of a communication may also vary with operating conditions. For example, a significant temperature variation may result in a variation of the signals exchanged.

The invention sets out to resolve these problems, and enable a power supply and communication entity to communicate with different actuators, or with a same actuator ACT, in variable conditions.

### SUMMARY OF THE INVENTION

The invention relates to a communication method for a home automation actuator comprising an electric motor driving a moving element in a building and two electric terminals making it possible to power the actuator by a power supply and communication entity and allowing communication between the actuator and the power supply and communication entity. The method comprises the following steps:
analysis of a power supply signal supplied by the power supply and communication entity;
generation of a first time-sequence of a response signal, representative of a predetermined calibration binary element, called first calibration sequence;
sending of a series of time-sequences of the response signal, representative of a series of binary elements, each binary element of this series, equal to the calibration binary element, being represented by a time-sequence which is an image of the first calibration sequence.

In a particular embodiment, the method also comprises, prior to the sending step, a step of generating a second time-sequence of the response signal, representative of an additional binary element to the calibration binary element, called second calibration sequence. In this embodiment, with an explicit sending of the second calibration sequence, the method is more robust and simple.

In another embodiment, the sending step comprises the generation, for each different binary element of the calibration binary element, of a time-sequence which is an image of the second calibration sequence. This allows the method to be more robust and simple regarding the step of sending data, since the representative time-sequence is known for the two binary elements that can constitute a data frame.

In a preferred embodiment the step of generation of the first calibration sequence comprises the following substeps:
configuration of the impedance of the actuator with a first value for a first duration;
configuration of the impedance of the actuator with a second value for a second duration.

The method may include, for the step of generation of the first calibration sequence, a substep of configuration of the impedance of said actuator with a third value for a third duration. Preferably, the communication is carried out by the actuator without any supplemental hardware element, using hardware elements that are previously in the motor, but configuring them differentally such that the first calibration sequence SeqCal can be generated.

In a particular embodiment, the method comprises a step of detection of a time variation of the power supply signal, representative of a calibration request sent by the power supply and communication entity. Thus the actuator can detect a calibration request sent by the entity IMS, following a change in the operating conditions that requires a new calibration. The communication is thus reset on the power supply and communication entity's initiative.

The method may also comprises a step of generation of a third time-sequence of the response signal, representative of a signaling of calibration sent by the actuator. Advantageously, the actuator can signal a new generation of calibration sequence SeqCal, following a change in the operating conditions that is detected by the actuator. The calibration is thus reset on the actuator's initiative.

The invention also relates to a communication method for a power supply and communication entity comprising two electric terminals making it possible:
to power a home automation actuator comprising an electric motor driving a moving element in a building and
to communicate with this actuator,
   the method comprising the following steps:
generation of a power supply signal between the electric terminals;
determination of a first time-sequence of a response signal, called first calibration sequence;
assignment of a meaning of representation of a first predetermined calibration binary element to the first calibration sequence;
reception of a series of time-sequences of the response signal, representative of a series of binary elements, each binary element of this series, equal to the calibration binary element, being represented by a time-sequence which is an image of the first calibration sequence.

In an embodiment, the method implemented by the power supply and communication entity comprises a step of determination of a second time-sequence of the response signal, representative of the additional binary element to the calibration binary element, called second calibration sequence.

In a preferred embodiment of the method implemented by the power supply and communication entity, the step of determination of the first calibration sequence comprises the following substeps:
determination of a first threshold value of the response signal;
determination of an extreme value of the response signal;
determination of a second threshold value of the response signal.

Thus, the power supply and communication entity can determine the calibration sequence irrespective of the duration of the time-sequence.

In a preferred embodiment of the method implemented by the power supply and communication entity, the step of reception of the series of time-sequences comprises the following substeps:
detection of a time-sequence of the response signal, representative of a binary element, called data sequence;
determination of the value of the binary element by comparing the data sequence with at least the first calibration sequence.

A data sequence that is an image of the first calibration sequence is interpreted as representing one bit of data equal to the binary element of calibration. The power supply and communication entity can receive data using the calibration sequence: representative sequences of binary elements are not predetermined, they can change from an actuator to another, or with the operating conditions. The method allows in this way the entity IMS to communicate with different actuators or in variable operating conditions.

In an embodiment of the method implemented by the power supply and communication entity, the step of detection of the data sequence comprises the following substeps:
detection of a first value of the response signal substantially equal to the first threshold value;
detection of a second value of the response signal substantially equal to the extreme value;
detection of a third value of the response signal substantially equal to the second threshold value.

In this way, the power supply and communication entity can determine the sequence of data regardless of the duration of the time-sequence, using the threshold values of the response signal.

In a particular embodiment, the method implemented by the power supply and communication entity comprises a step of generation of a time variation of the power supply signal, representative of a calibration request sent by the power supply and communication entity. The entity, following a change of the operating conditions requiring a new calibration, may thus request the generation of a new sequence of calibration; the communication is then reset, i.e. recalibrated, at the initiative of the power supply and communication entity.

The method implemented by the power supply and communication entity may also comprise a step of detection of a third time-sequence of the response signal, representative of a signaling of calibration sent by the actuator. The power supply and communication entity can in this way detect the signalisation of a new generation of a calibration sequence, following a change in the operating conditions of operating detected by the actuator. The communication is then reset or recalibrated, at the initiative of the actuator.

The invention also relates to a communication method for a system comprising
at least one power supply and communication entity comprising two electric terminals, and
at least one home automation actuator comprising an electric motor for driving a moving element in a building and two electric terminals,
   a connection between the electric terminals making it possible to power the actuator by the power supply and communication entity and allowing communication between the actuator and the power supply and communication entity,
   the method comprising the following steps:
generation, by the power supply and communication entity, of a power supply signal between the electric terminals;
analysis, by the actuator, of the power supply signal;
generation, by the actuator, of a first time-sequence of a response signal, representative of a first predetermined calibration binary element, called first calibration sequence;
determination, by the power supply and communication entity, of the first calibration sequence;
assignment, by the power supply and communication entity, of a meaning of representation of the predetermined calibration binary element, to the first calibration sequence;
sending, by the actuator, of a series of time-sequences of the response signal, representative of a series of binary elements, each binary element of this series, equal to the calibration binary element, being represented by a time-sequence which is an image of the first calibration sequence;
reception, by the power supply and communication entity, of the series of time-sequences of the response signal, representative of the series of binary elements.

The invention also relates to a home automation actuator comprising
an electric motor driving a moving element in a building;
two electric terminals making it possible to power the actuator by a power supply and communication entity and allowing communication between the actuator and the power supply and communication entity;
means
for analyzing the power supply signal supplied by the power supply and communication entity;
for generating a first time-sequence of a response signal, representative of a predetermined calibration binary element, called first calibration sequence;
for sending a series of time-sequences of the response signal, representative of a series of binary elements, each binary element of this series, equal to the calibration binary element, being represented by a time-sequence which is an image of the first calibration sequence.

The invention also relates to a power supply and communication entity comprising
two electric terminals making it possible to power a home automation actuator comprising an electric motor driving a moving element in a building and allowing communication with this actuator;
means
for generating a power supply signal between the electric terminals;
for determining a first time-sequence of a response signal, called first calibration sequence;
for assigning a meaning of representation of a first predetermined calibration binary element to the first calibration sequence;
for receiving a series of time-sequences of the response signal, representative of a series of binary elements, each binary element of this series, equal to the calibration binary element, being represented by a time-sequence which is an image of the first calibration sequence.

The invention also relates to a system comprising at least one power supply and communication entity and at least one actuator as defined previously.

The invention also relates to a storage medium that can be read by a processor on which is stored a computer program comprising instructions for executing the steps of the communication method for an actuator defined previously.

The invention also relates to a storage medium that can be read by a processor on which is stored a computer program comprising instructions for executing the steps of the communication method for a power supply and communication entity defined previously.

### BRIEF DESCRIPTION OF THE FIGURES

FIG. 1 represents a system SYS implementing the invention.

FIGS. 2a and 2b represent, in simplified form, two embodiments of a motor forming part of an actuator according to the invention.

FIGS. 3, 3a and 3b represent, in flow diagram form, the main steps of a communication method according to the invention, implemented by a power supply and communication entity IMS.

FIGS. 4, 4a and 4b represent, in flow diagram form, the main steps of a communication method according to the invention, implemented by an actuator ACT.

FIG. 5 represents a series of time-sequences of the response signal used for the uplink communication.

FIG. 6 represents the main exchanges between a power supply and communication entity IMS and an actuator ACT, in a system SYS according to the invention.

### DETAILED DESCRIPTION OF A PREFERRED EMBODIMENT

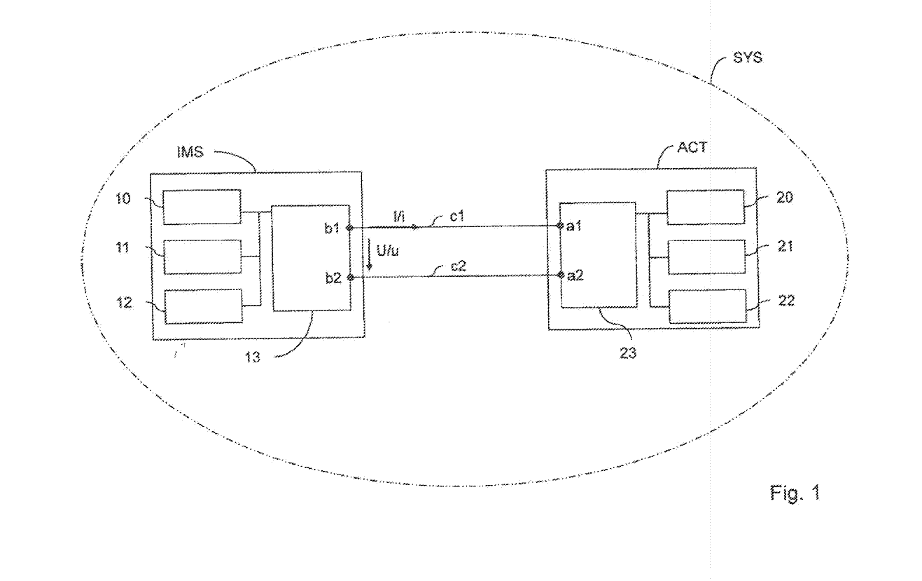

FIG. 1 shows a home automation system comprising a power supply and communication entity IMS comprising a processor 10, a random access memory of RAM type 11, a non-volatile program memory, possibly rewritable, of ROM or flash type 12 and a line interface 13 making it possible to power an actuator ACT and allowing communication therewith via two electric terminals b1, b2.

FIG. 1 also shows the actuator ACT comprising a processor 20, a random access memory of RAM type 21, a non-volatile program memory, possibly rewritable, of ROM or flash type 22 and a line interface 23 for receiving the power supply voltage and communicating with the power supply and communication entity IMS via two electric terminals a1, a2. The actuator is preferentially a home automation actuator. It comprises an electric motor driving a moving element of a building, such as a moving closure, blind, solar protection or screen element.

The line interfaces 13 and 23 are connected by two wires c1, c2 capable of connecting the actuator ACT to an electric power supply generated by the power supply and communication entity IMS and of forming a physical communication medium between the actuator ACT and the power supply and communication entity IMS.

The power supply and communication entity IMS supplies the actuator ACT with an electrical power supply signal, in the form of a voltage signal U or electric current i.

This signal is generated by the power supply and communication entity IMS between its electric terminals b1, b2.

The wires c1, c2 produce an electrical connection between the electric terminals b1, b2 of the power supply and communication entity IMS and the electric terminals a1, a2 of the actuator ACT, thus allowing for the electrical power supply thereof.

Hereinafter in this document, the electrical power supply signal, supplied by the power supply and communication entity IMS to the actuator ACT, is called “power supply signal”.

The actuator ACT constitutes, as seen from its terminals a1, a2, a load impedance for the power supply and communication entity IMS.

Following the connection of the wires c1, c2, between the electric terminals a1, a2, of the actuator ACT and b1, b2, of the power supply and communication entity IMS, an electrical signal is established in response: if the electrical power supply is supplied in the form of a voltage signal U, this signal is the intensity of the electrical current I.

Alternatively, the power supply may be supplied in the form of an electrical current signal i; in this case, the signal established in response is an electrical voltage u.

Hereinafter in this document, the signal which is established following the generation of the power supply signal U, i, and the connection of the wires c1, c2, between the electric terminals a1, a2, of the actuator ACT and b1, b2, of the power supply and communication entity IMS, is called “response signal”.

Thus, these power supply and response signals are therefore present on the wires c1, c2 and at the terminals a1, a2 and b1, b2.

The response signal which is established depends on the one hand on the power supply signal supplied by the power supply and communication entity IMS and on the other hand on the impedance of the actuator ACT. This is because, the latter, by provoking a variation of its impedance Zact, creates a variation of the response signal and thus transmits an information item to the power supply and communication entity IMS.

The communication between the actuator ACT and the power supply and communication entity IMS is then carried out by the sending of data by the actuator ACT, in the form of a data frame forming at least part of the response signal. The data frame preferentially corresponds to a series of binary elements, represented by variations of the response signal circulating on the wires c1, c2.

The power supply and communication entity IMS comprises means for detecting current and voltage respectively. By using techniques known to a person skilled in the art, such as sampling and storage, the power supply and communication entity IMS can determine the variations in time of the response signal. A set of the variations in time of the response signal during a time period is hereinafter in this document called “time-sequence of the response signal”. The duration of the time period is determined according to a criterion shared by the actuator ACT and the power supply and communication entity IMS. Such a criterion can be a predetermined duration or the passage of the response signal, during its variations, through predefined threshold values, and possibly through extreme values between these predefined threshold values. The two criteria can be combined to delimit one and the same sequence, as will be explained hereinbelow.

A time-sequence of the response signal can be represented by a first time graph. Any set of time variations of the response signal that can be represented by a second time graph that is identical or substantially identical to the first time graph is called “image” of a time-sequence.

The communication methods according to the invention are, for example, implemented in a system SYS represented in FIG. 1.

This system SYS comprises a power supply and communication entity IMS, comprising two electric terminals b1, b2, and at least one home automation actuator ACT comprising an electric motor for driving a moving element in a building and two electric terminals a1, a2. A connection by wires c1, c2, between the electric terminals of the power supply and communication entity IMS, b1, b2, and those of the actuator, a1, a2, make it possible to power the actuator ACT by the power supply and communication entity IMS and allow communication between the actuator ACT and the power supply and communication entity IMS.

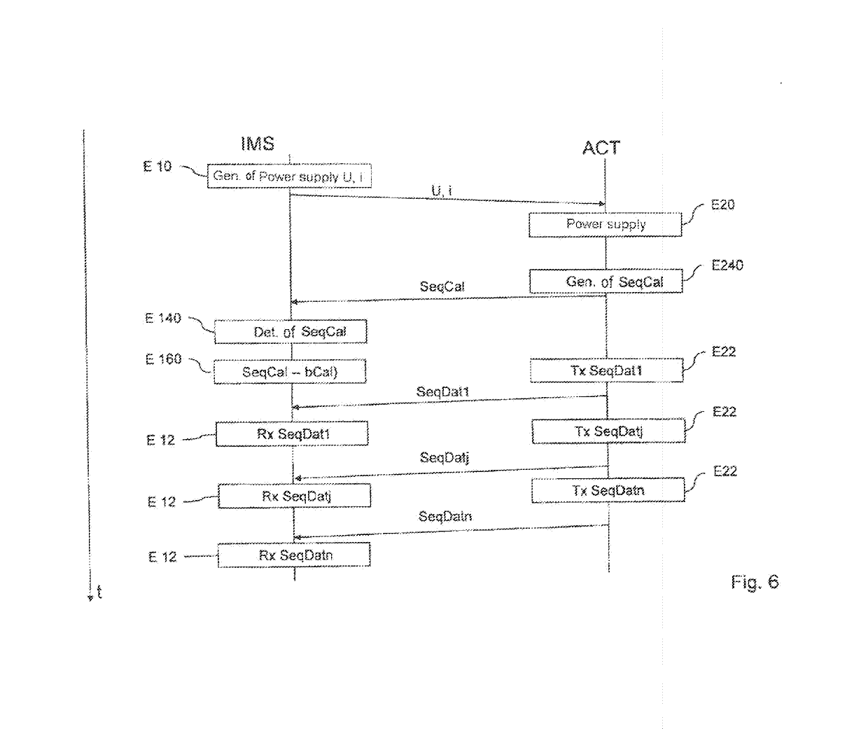

With reference to FIG. 6, the main steps of a mode of execution of a communication method according to the invention will now be described. Generally, this communication method for the system SYS comprises the following steps:
a step E10, implemented by the power supply and communication entity IMS, of generation of a power supply signal in voltage U, respectively in current i, between the electric terminals b1, b2;
a step E20, implemented by the actuator ACT, of analysis of the power supply signal U, respectively i;
a step E240, implemented by the actuator ACT, of generation of a first time-sequence of a response signal in current I, respectively in voltage u, representative of a first predetermined calibration binary element bCal, called first calibration sequence SeqCal;
a step E140, implemented by the power supply and communication entity IMS, of determining the first calibration sequence SeqCal;
a step E160, implemented by the power supply and communication entity IMS, of assignment of a meaning of representation of the predetermined calibration binary element bCal, to the first calibration sequence SeqCal;
a step E22, implemented by the actuator ACT, of sending of a series of time-sequences of the response signal I, respectively u, representative of a series of binary elements, each binary element of this series, equal to the calibration binary element bCal, being represented by a time-sequence which is an image of the first calibration sequence SeqCal;
a step E12, implemented by the power supply and communication entity IMS, of reception of the series of time-sequences of the response signal I, respectively u, representative of the series of binary elements.

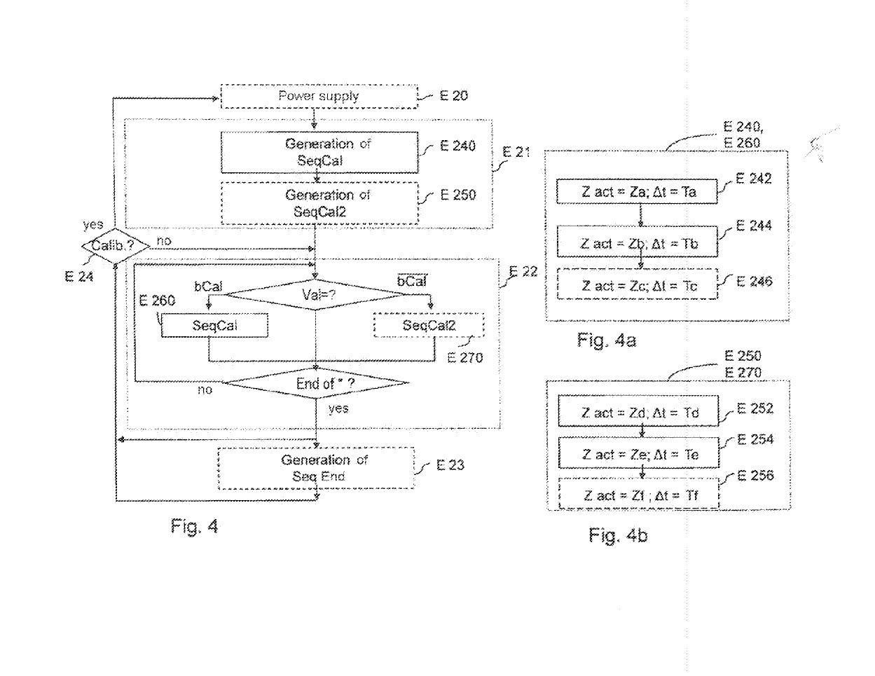

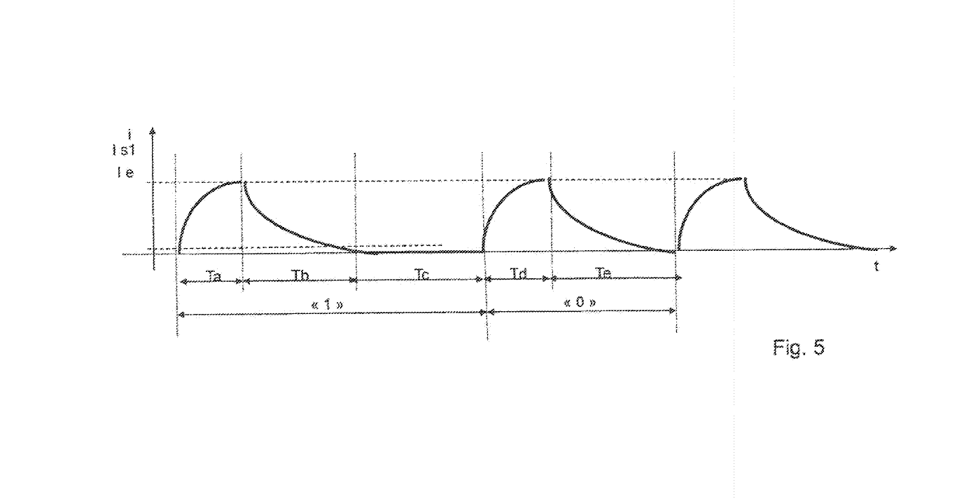

An embodiment of the communication method implemented by an actuator ACT is described with reference to FIGS. 4, 4a, 4b and 5.

The actuator ACT determines, during a step E20, whether a power supply signal voltage U, respectively in current i, is supplied at its terminals a1, a2.

Then, the actuator ACT generates, during a step E240, a first time-sequence of the response signal, representative of a predetermined calibration binary element bCal, called first calibration sequence SeqCal.

The second binary element, complementary to the calibration binary element bCal, can be represented by a second calibration sequence SeqCal2.

This second calibration sequence SeqCal2 can be generated by the actuator ACT, during a step E250. Alternatively, the second calibration sequence SeqCal2 can be deduced from the first calibration sequence SeqCal, for example by the addition or removal of a predetermined part of the image of the first calibration sequence SeqCal.

It should be noted that only the first calibration sequence SeqCal needs to be known, the complementary binary element being able to be made up by any sequence, not necessarily always the same, different from the first calibration sequence SeqCal. The calibration sequence of the complementary binary element can also be deduced from the first calibration sequence.

The step E240 of generation of the first calibration sequence SeqCal, possibly followed by the optional step E250 of generation or deduction of the second calibration sequence SeqCal2, constitutes/constitute a calibration step E21.

The role of this step E21 is to transmit to the power supply and communication entity IMS the information concerning the encoding of the data which will be transmitted subsequently. In this way, the encoding can change on each new connection and/or on each modification of transmission conditions.

The calibration step E21 is followed by a step E22 of sending of a data frame, in the form of a series of time-sequences of the response signal I, respectively u, representative of a series of binary elements forming the data frame to be sent.

The actuator ACT generates, for each data binary element equal to the calibration binary element bCal, a time-sequence of the response signal, that is an image of the first calibration sequence SeqCal.

A data binary element complementary to the calibration bit bCal can be represented by a time-sequence of the response signal that is an image of the second calibration sequence SeqCal2.

The actuator ACT can have a data frame to be sent, for example:
following a reception of a frame previously sent by the power supply and communication entity IMS, if this frame asks for an acknowledgement or application information from the actuator ACT;
following a self-test (a test of itself) performed by the actuator ACT after it is powered up, in order to transmit to the power supply and communication entity IMS the result of the self-test and information such as the hardware and software version, batch number, operating parameters;
following an event detected by the actuator, with no prior request from the power supply and communication entity IMS.

In one embodiment, the actuator ACT and the power supply and communication entity IMS use dedicated wires for the electrical power supply, and dedicated wires c1, c2 for the communication. In this case, the voltage, respectively current, generator used for the communication can supply signals U, respectively i, only for the power supply for the communication interface. This interface comprises the terminals b1, b2 of the power supply and communication entity IMS, the terminals a1, a2 of the actuator ACT and the wires c1, c2.

Alternatively, the actuator ACT and the power supply and communication entity IMS use the same wires c1, c2, to implement different, mutually exclusive operating modes, such as a command execution mode and a downlink and/or uplink communication mode. The same wires c1, c2 are used to power the actuator ACT, regardless of the operating mode.

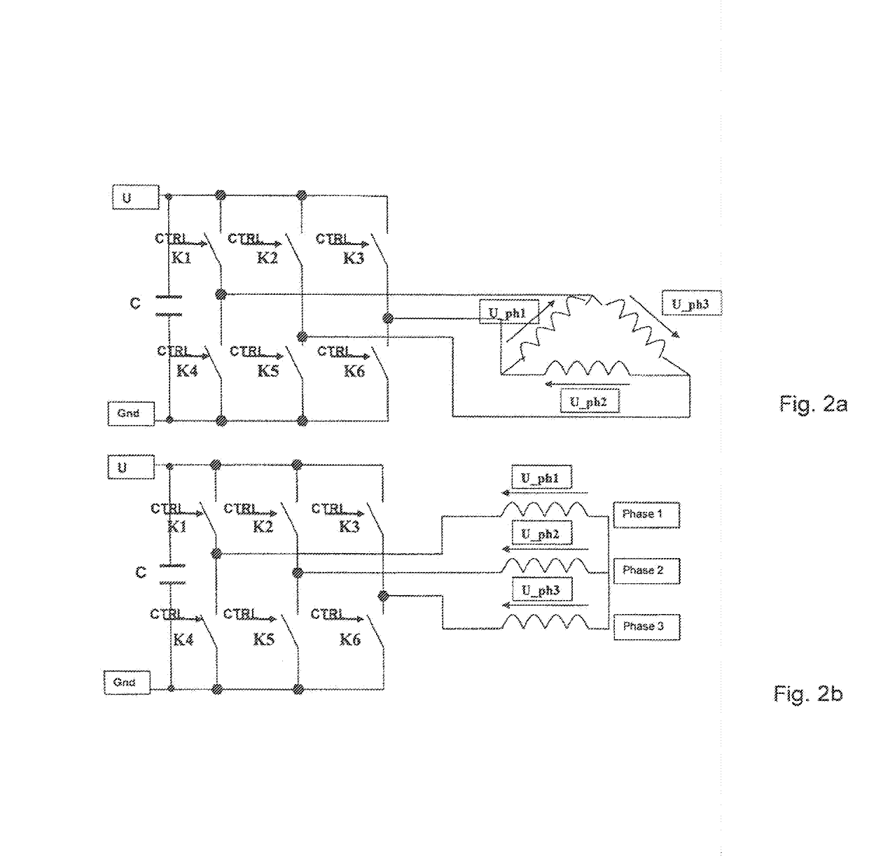

During the command execution mode, the operation of the motor is controlled by electronic components as illustrated schematically by FIGS. 2a and 2b.

During the uplink communication mode, the actuator ACT uses the electronic components, used in command execution mode to control the motor, differently, that is to say to configure the actuator as load impedance having particular values.

By varying the configuration of the electronic components, the actuator ACT can vary the load impedance Zact presented to the power supply and communication entity IMS; in this way, the actuator ACT can generate variations of the response signal in current, respectively in voltage, at its terminals a1, a2 and on the wires c1, c2.

Whatever the configuration, wires c1, c2, dedicated to communication or same wires c1, c2, used for the power supply and communication, the actuator implements the sending of a frame over these wires c1, c2, by varying its input impedance.

In this way, for a power supply signal in voltage U, the actuator ACT will provoke a variation of the response signal in current I, and for a power supply signal in current i, a variation of the response signal in voltage u.

The invention can be implemented by an actuator ACT using motors known to a person skilled in the art as “brushless” motors, schematically represented in FIGS. 2a and 2b.

The control of these motors in normal operation is handled by the electronic switches K1, K2, K3, K4, K5 and K6, implemented, for example, by using MOS transistors or insulated gate bipolar transistors, under the control of a module CTRL which is not represented.

In uplink communication mode, the control module CTRL can configure the switches K1, K2, K3, K4, K5 and K6 differently; in this case, the load impedance presented by the motor of the actuator ACT varies according to the configuration of the electronic switches.

In the example illustrated by FIG. 5, the actuator ACT is powered by voltage. To represent a given binary element, the actuator ACT generates a time-sequence of the response signal in current I, respectively in voltage u, by varying the configuration of the switches Ki according to a sequence that is specific to each binary element; the result of this is a current time-sequence specific to each binary element.

The invention can be implemented by an actuator ACT using other known types of motors, such as an asynchronous, synchronous, universal (DC), stepper or piezoelectric motor.

The values of the impedances can vary from one product to another or, for one and the same product, with the operating conditions. For the same power supply signal voltage U, respectively in current i, the time-sequences of the response signal in current, respectively in voltage, can therefore be different.

In the example illustrated by FIGS. 4, 4a et 4b and 5, the step E240 of generation of the first calibration sequence SeqCal, representative of the predefined calibration binary element bCal, with a value of, for example, “1”, comprises a substep E242 of maintaining a first configuration of the switches, ensuring an impedance Za for a first duration Ta. This configuration allows for the variation of the response signal in current I, respectively in voltage u, up to an extreme value, minimum or maximum, Iₑ, uₑ.

Then, a substep E244 of maintaining a second configuration of the switches, ensuring an impedance Zb for a second duration Tb, is executed. In the case of a power supply in voltage U, this second configuration makes it possible to recharge capacitive elements C of the actuator ACT, resulting in a decrease in the response signal in current I.

A third substep E246 of maintaining a third configuration of the switches ensures an impedance Zc for a third duration Tc. In the case of a power supply in voltage, this configuration can correspond to maintaining a response signal in current I that is virtually zero on the wires c1, c2.

Similarly, the complementary binary element, with a value, for example, of “0”, can be represented by a sequence of two configurations of the switches respectively ensuring the impedances Zd, Ze for durations Td, Te.

The values Zd, Td can be equal to Za. Ta, and the values Ze, Te can be equal to Zb, Tb. The time-sequence constituting the bit of value “0” can differ from the time-sequence constituting the bit of value “1” only in that it does not comprise any substep of maintaining a configuration of the switches, ensuring the impedance Zc for the duration Tc. In particular, the latter configuration may not exist, in other words Tc=0. Such an embodiment is illustrated by FIG. 5.

Other embodiments can be implemented
by adding to the sequences representative of the two binary elements durations Ti, Tj of the impedance Zi, respectively Zj, configurations; or
by removing sequences, for example the optional substep E246 for the steps E240, E260.

The values of the times Ta, Tb, Tc, Td, Te, Ti and Tj can be predetermined. Alternatively, the corresponding configurations ensuring the impedances Za, . . . , Zj are maintained as long as the response signal current I, respectively in voltage u, on the wires c1, c2 has not reached predetermined values Iₐ, . . . , Iⱼ, respectively uₐ, . . . , uⱼ.

The two methods can be used for one and the same sequence: the durations Ta and Tb can be determined as a function of the response signal in current I, respectively in voltage u; the duration Tc can be predetermined.

For example, the duration Ta is the duration of variation of the response signal between a predefined first threshold value Is1, respectively us1, and an extreme value Iₑ, respectively uₑ; Tb is the duration of variation of the response signal between the extreme value Iₑ, respectively uₑ, and a predefined second threshold value Is2, us2.

In the embodiment represented, the actuator ACT sends, during a step E22, the binary elements constituting the data frame, by generating, according to the value of the binary element to be sent:
the first calibration sequence SeqCal, if the binary element to be sent is equal to the calibration bit bCal, during a step E260; or
the second calibration sequence SeqCal2, if the binary element to be sent is complementary to the calibration bit bCal, during a step E270.

In one embodiment, the actuator can send, during a step E23, after the sending of the data, a fourth time-sequence of the response signal indicating the end of the frame.

As already mentioned, a calibration step E21 is executed by the actuator ACT to transmit to the power supply and communication entity IMS the information concerning the encoding of the information which will be transmitted subsequently.

This step can be executed several times during one and the same connection (or one and the same operating mode) if the transmission conditions change. Such a change, requiring a new calibration, can be detected by each element of the system SYS and signaled to the remote element, as explained hereinbelow in this document.

The method implemented by the actuator ACT comprises a decision step E24 to decide whether a new calibration step E21 needs to be executed. From the point of view of the actuator ACT, two situations can occur: the actuator ACT itself detects a significant change in the operating conditions, requiring a new calibration, or the power supply and communication entity IMS sends a calibration request, and the actuator detects this request.

In the first case, a new calibration can be signaled by the actuator ACT to the power supply and communication entity IMS during the step E24, by the generation of a predetermined third time-sequence of the response signal in current IReqCal2, respectively in voltage uReqCal.

A new sending of the calibration sequence SeqCal can be initiated by the actuator ACT if the number of transmission errors detected is too great. This error detection can be performed using known techniques, such as the repetition of a frame by the actuator if this frame is not acknowledged by the power supply and communication entity within a predetermined time.

In the second case, the actuator ACT may detect, during the step E24, a predetermined time variation of the power supply signal, uReqCal, respectively of the current iReqCal, generated by the power supply and communication entity IMS. Following this detection, the actuator ACT can once again generate the first calibration sequence SeqCal, followed in some embodiments by the generation of the second calibration sequence SeqCal2.

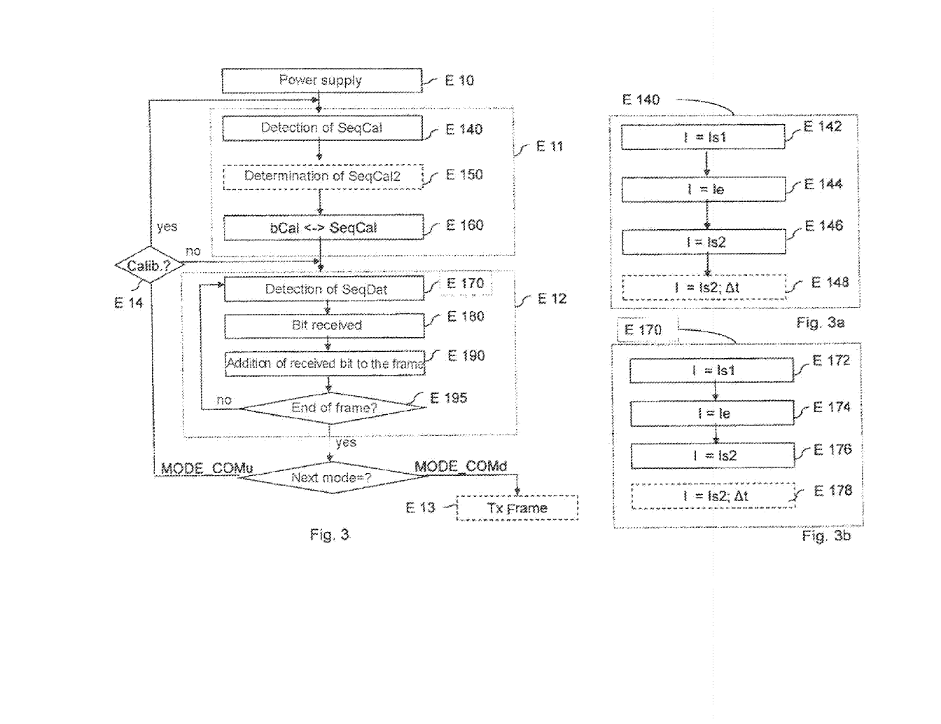

A mode of execution of the method implemented by the power supply and communication entity IMS is now described with reference to FIGS. 3, 3a and 3b.

The power supply and communication entity IMS determines the first calibration sequence SeqCal, during a step E140, that is to say that the power supply and communication entity determines or identifies electrical characteristics of the response signal, in particular electrical characteristics for a duration that is either predetermined or determined as a function of the response signal, as explained above.

A meaning of representation of a first predetermined calibration binary element bCal is assigned to the first calibration sequence (SeqCal) during a step E160; that is to say that the power supply and communication entity assigns a meaning to the first calibration sequence, in particular, it can assign the value “1” or the value “0” to the first calibration sequence SeqCal.

Then, during a step E12, the power supply and communication entity IMS receives at least one data frame made up of a series of binary elements. Each binary element is represented by a time-sequence of the response signal in current I, respectively in voltage u, called data sequence SeqDat. These data sequences, detected between the terminals b1, b2, are representative either of the calibration binary element bCal, or of the complementary binary element. Each data binary element equal to the calibration binary element bCal is represented by a time-sequence of the response signal that is an image of the first calibration sequence SeqCal.

The power supply and communication entity IMS, having means for determining the time-sequences of the response signal I, u, on the wires c1, c2, can deduce the binary elements transmitted.

The power supply and communication entity IMS comprises means for sampling and storing the response signal in current I, respectively in voltage u, detected between its terminals b1, b2. The power supply and communication entity IMS can thus determine the image of the time-sequence of the response signal I, u.

The power supply and communication entity IMS supplies the electrical power supply to the actuator ACT, during a step E10. This power supply can originate from a DC or AC voltage generator or from a current generator. The electrical power supply is generated by the power supply and communication entity IMS between its electric terminals b1, b2, connected via the wires c1, c2, to the electric terminals of the actuator ACT, a1, a2.

Then, the power supply and communication entity IMS determines, during a step E140, a first time-sequence of a response signal I, respectively u, called first calibration sequence SeqCal.

A meaning of representation of a first predetermined binary element, bCal, is assigned, during a step E160, to the first calibration sequence SeqCal.

In one embodiment, the step E140 of determining the calibration sequence SeqCal comprises the following substeps:

E142 for determining the start of the sequence, when the response signal in current I, respectively in voltage u, on the wires c1, c2, reaches a first predetermined threshold value, Is1, respectively us1;

E144 for determining an extreme value, minimum or maximum, of the response signal in current Iₑ, respectively in voltage uₑ, on the wires c1, c2; this determination uses known techniques, such as signal sampling, storage and processing;

E146 for determining the end of the sequence when the response signal in current I, respectively in voltage u, generated on the wires c1, c2 reaches a second threshold value Is2, respectively us2.

The step E140 may comprise an optional substep E148 of detection of a response signal in current I, respectively in voltage u, having a value substantially equal to the second threshold value Is2, respectively us2, for a predetermined duration.

The response signal in current I, respectively in voltage u, is thus sampled and stored between the start and the end of the sequence SeqCal.

The second binary element, complementary to the calibration binary element bCal, may be represented by a second calibration sequence SeqCal2.

This second calibration sequence SeqCal2 can be detected by the power supply and communication entity IMS during a step E150.

Alternatively, the second calibration sequence SeqCal2 can be deduced from the first calibration sequence SeqCal, for example by adding or removing a predetermined part of the image of the first calibration sequence SeqCal.

It should be noted that only the first calibration sequence SeqCal needs to be known, the second binary element being able to be made up of any sequence, not necessarily always the same, but is different from the first calibration sequence SeqCal.

Then, during a step E12, the power supply and communication entity IMS receives a series of time-sequences of the response signal in current I, respectively in voltage u, representative of a series of binary elements, each binary element equal to the calibration binary element bCal being represented by a time-sequence that is an image of the first calibration sequence SeqCal. The power supply and communication entity deduces from this series of time-sequences a series of useful information items.

In the example illustrated by FIGS. 3, 3a and 3b, the reception step E12 comprises a substep E170 of detection of a time-sequence of the response signal in current I, respectively u, representative of a binary element bDat, called data sequence SeqDat.

In one embodiment, the step E170 of detection of the data sequence SeqDat comprises the following substeps:
detection E172 of a first value of the response signal in current I, respectively u, generated on the wires c1, c2, substantially equal to the first threshold value Is1, us1;
detection E174 of a second value of the response signal in current I, respectively u, generated on the wires c1, c2, substantially equal to the extreme value Iₑ, respectively uₑ;
detection E176 of a third value of the response signal in current I, respectively in voltage u, generated on the wires c1, c2, substantially equal to the second threshold value Is2, us2.

The step E170 may comprise an optional substep E178 of detection of a response signal in current I, respectively in voltage u, having a value substantially equal to the second threshold value Is2, respectively us2, for a predetermined duration.

Once the sequence SeqDat is determined, the power supply and communication entity can determine, during a substep E180, the value of the binary element bDat by comparing the data sequence SeqDat with at least the first calibration sequence SeqCal: a data sequence, the image of the first calibration sequence SeqCal, is interpreted by the power supply and communication entity IMS as a data binary element equal to the calibration binary element bCal.

If the embodiment implements a step of determination, by detection or deduction, of the second calibration sequence SeqCal2, the data sequence SeqDat can be compared, during the substep E180, with the two calibration sequences, SeqCal, SeqCal2.

In one embodiment, the end of a data frame is determined during a step E195, by the detection of an end-of-frame-specific time-sequence of the response signal. Alternatively, the end of a frame can be determined by comparing the number of bytes received with the number of bytes expected.

The step E140 of detection of the first calibration sequence SeqCal, possibly followed by the optional step E150 of detection of the second calibration sequence SeqCal2, constitutes/constitute a calibration detection step E11.

The role of this step E11 is to enable the power supply and communication entity IMS to determine the information concerning the encoding of the data which will be transmitted subsequently. In this way, the encoding can change on each new connection and/or on each modification of transmission conditions.

A calibration detection step E11 is executed at least once, following the connection between the power supply and communication entity IMS and the actuator ACT, but it can be executed several times during one and the same connection, for example if a temperature variation is detected, or if the number of transmission errors is too high. This error detection can be performed using known techniques, such as CRCs, parity bits, or any other sequence intended to check the integrity of received data.

A change of operating conditions, detected by the power supply and communication entity IMS, can be signaled to the actuator ACT during a step E14 by the generation of a predetermined time variation of the power supply signal UReqCal1, respectively iReqCal1. This time variation of the power supply signal constitutes a calibration request sent by the power supply and communication entity IMS.

A change of operating conditions requiring a new calibration can be signaled also by the actuator ACT; in this case, a third time-sequence of the response signal in current, IReqCal2, respectively in voltage, uReqCal2, is generated by the actuator ACT.

The power supply and communication entity IMS can detect, during the step E14, this predetermined third time-sequence of the response signal IReqCal2, respectively of the voltage uReqCal2.

The power supply and communication entity IMS can therefore, during the step E14, detect or generate a calibration request and thus determine that the next step to be executed is a step E140 of determining the calibration sequence SeqCal.

1. A communication method for a home automation actuator (ACT) comprising an electric motor driving a moving element in a building and two electric terminals (a1, a2) making it possible to power the actuator (ACT) by a power supply and communication entity (IMS) and allowing communication between the actuator (ACT) and the power supply and communication entity (IMS), the method comprising the following steps:
analysis (E20) of a power supply signal (U, i) supplied by the power supply and communication entity (IMS);
generation (E240) of a first time-sequence of a response signal (I, u), representative of a predetermined calibration binary element (bCal), called first calibration sequence (SeqCal);
sending (E22) of a series of time-sequences of the response signal (I, u), representative of a series of binary elements, each binary element of this series, equal to the calibration binary element (bCal), being represented by a time-sequence which is an image of the first calibration sequence (SeqCal).

2. The method as claimed in claim 1, in which the method also comprises, prior to the sending step (E22), a step (E250) of generating a second time-sequence of the response signal (I,u), representative of an additional binary element to the calibration binary element (bCal), called second calibration sequence (SeqCal2).

3. The method as claimed in claim 2, in which the sending step (E22) comprises the generation, for each different binary element of the calibration binary element (bCal), of a time-sequence which is an image of the second calibration sequence (SeqCal2).

4. The method as claimed in claim 1, in which the step (E240) of generation of the first calibration sequence (SeqCal) comprises the following substeps:
configuration (E242) of the impedance (Zact) of the actuator with a first value (Za) for a first duration (Ta);
configuration (E244) of the impedance (Zact) of the actuator with a second value (Zb) for a second duration (Tb).

5. The method as claimed in claim 4, in which the step (E240) of generation of the first calibration sequence (SeqCal) comprises a substep of configuration (E246) of the impedance (Zact) of said actuator with a third value (Zc) for a third duration (Tc).

6. The method as claimed in claim 1, in which the method comprises a step (E24) of detection of a time variation (UReqCal1, iReqCal1) of the power supply signal (U, i), representative of a calibration request sent by the power supply and communication entity (IMS).

7. The method as claimed in claim 1, in which the method comprises a step (E24) of generation of a third time-sequence (IReqCal2, uReqCal2) of the response signal (I, u), representative of a signaling of calibration sent by the actuator (ACT).

8. A communication method for a power supply and communication entity (IMS) comprising two electric terminals (b1, b2) making it possible:
to power a home automation actuator (ACT) comprising an electric motor driving a moving element in a building and
to communicate with this actuator (ACT),
the method comprising the following steps:
generation (E10) of a power supply signal (U, i) between the electric terminals (b1, b2);
determination (E140) of a first time-sequence of a response signal (I, u), called first calibration sequence (SeqCal);
assignment (E160) of a meaning of representation of a first predetermined calibration binary element (bCal) to the first calibration sequence (SeqCal);
reception (E12) of a series of time-sequences of the response signal (I, u), representative of a series of binary elements, each binary element of this series, equal to the calibration binary element (bCal), being represented by a time-sequence which is an image of the first calibration sequence (SeqCal).

9. The method as claimed in claim 8, in which the method also comprises a step (E150) of determination of a second time-sequence of the response signal (I,u), representative of the additional binary element to the calibration binary element (bCal), called second calibration sequence (SeqCal2).

10. The method as claimed in claim 8, in which the step (E140) of determination of the first calibration sequence (SeqCal) comprises the following substeps:
determination (E142) of a first threshold value (Is1, us1) of the response signal (1, u);
determination (E144) of an extreme value (Iₑ, uₑ) of the response signal (I, u);
determination (E146) of a second threshold value (Is2, us2) of the response signal (I, u).

11. The communication method as claimed in claim 8, in which the step of reception (E12) of the series of time-sequences comprises the following substeps:
detection (E170) of a time-sequence of the response signal (I, u), representative of a binary element (bDat), called data sequence (SeqDat);
determination (E180) of the value of the binary element (bDat) by comparing the data sequence (SeqDat) with at least the first calibration sequence (SeqCal).

12. The communication method as claimed in claim 8, in which the step (E170) of detection of the data sequence (SeqDat) comprises the following substeps;
detection (E172) of a first value of the response signal (I, u) substantially equal to the first threshold value (Is1, us1);
detection (E174) of a second value of the response signal (I, u) substantially equal to the extreme value (Iₑ, uₑ);
detection (E176) of a third value of the response signal (I, u) substantially equal to the second threshold value (Is2, Us2).

13. The method as claimed in claim 8, in which the method comprises a step (E14) of generation of a time variation (UReqCal1, iReqCal1) of the power supply signal (U, i), representative of a calibration request sent by the power supply and communication entity (IMS).

14. The method as claimed in claim 8, in which the method comprises a step (E14) of detection of a third time-sequence (IReqCal2, uReqCal2) of the response signal (I, u), representative of a signaling of calibration sent by the actuator (ACT).

15. A communication method for a system (SYS) comprising
at least one power supply and communication entity (IMS) comprising two electric terminals (b1, b2), and
at least one home automation actuator (ACT) comprising an electric motor for driving a moving element in a building and two electric terminals (a1, a2),
a connection between the electric terminals (b1, b2, a1, a2) making it possible to power the actuator (ACT) by the power supply and communication entity and allowing communication between the actuator (ACT) and the power supply and communication entity (IMS),
the method comprising the following steps:
generation (E10), by the power supply and communication entity (IMS), of a power supply signal (U, i) between the electric terminals (b1, b2);
analysis (E20), by the actuator (ACT), of the power supply signal (U, i);
generation (E240), by the actuator (ACT), of a first time-sequence of a response signal (I, u), representative of a first predetermined calibration binary element (bCal), called first calibration sequence (SeqCal);
determination (E140), by the power supply and communication entity (IMS), of the first calibration sequence (SeqCal);
assignment (E160), by the power supply and communication entity (IMS), of a meaning of representation of the predetermined calibration binary element (bCal), to the first calibration sequence (SeqCal);
sending (E22), by the actuator (ACT), of a series of time-sequences of the response signal (I, u), representative of a series of binary elements, each binary element of this series, equal to the calibration binary element (bCal), being represented by a time-sequence which is an image of the first calibration sequence (SeqCal);
reception (E12), by the power supply and communication entity (IMS), of the series of time-sequences of the response signal (I, u), representative of the series of binary elements.

16. A home automation actuator (ACT) comprising
an electric motor driving a moving element in a building;
two electric terminals (a1, a2) making it possible to power the actuator (ACT) by a power supply and communication entity (IMS) and allowing communication between the actuator (ACT) and the power supply and communication entity (IMS);
means (20, 21, 22, 23)
for analyzing the power supply signal (U, i) supplied by the power supply and communication entity (IMS);
for generating a first time-sequence of a response signal (I, u), representative of a predetermined calibration binary element (bCal), called first calibration sequence (SeqCal);
for sending a series of time-sequences of the response signal (I, u), representative of a series of binary elements, each binary element of this series, equal to the calibration binary element (bCal), being represented by a time-sequence which is an image of the first calibration sequence (SeqCal).

17. A storage medium (22) that can be read by a processor (20) on which is stored a computer program comprising instructions for executing the steps of the communication method as claimed in claim 1.

18. A power supply and communication entity (IMS) comprising
two electric terminals (b1, b2) making it possible to power a home automation actuator (ACT) comprising an electric motor driving a moving element in a building and allowing communication with this actuator (ACT);
means (10, 11, 12, 13)
for generating a power supply signal (U, i) between the electric terminals (b1, b2);
for determining a first time-sequence of a response signal (I, u), called first calibration sequence (SeqCal);
for assigning a meaning of representation of a first predetermined calibration binary element (bCal) to the first calibration sequence (SeqCal);
for receiving a series of time-sequences of the response signal (I, u), representative of a series of binary elements, each binary element of this series, equal to the calibration binary element (bCal), being represented by a time-sequence which is an image of the first calibration sequence (SeqCal).

19. A storage medium (12) that can be read by a processor (10) on which is stored a computer program comprising instructions for executing the steps of the communication method as claimed in claim 8.

20. A system (SYS) comprising at least one power supply and communication entity (IMS) and at least one actuator (ACT) as claimed in claim 16.
